(19) United States
(12) Patent Application Publication
(10) Pub. No.: US 2004/0262871 A1
(43) Pub. Date: Dec. 30, 2004

(54) A Motorized Personal Vehicle

(75) Inventors: Marcel Arthur Jan Schreuder, Amsterdam (NL); Willem Jorrit Schoonhoven, Amsterdam (NL); Michiel Sebastiaan Emamnuel Petrus Knoppert, Amsterdam (NL); Leonard F. Antao, Smyrna, GA (US); Daniel R. Peters, Alpharetta, GA (US); Arthur G. Rudick, Atlanta, GA (US)

Correspondence Address: SUTHERLAND ASBILL & BRENNAN LLP, 999 PEACHTREE STREET, N.E., ATLANTA, GA, 30309, US

(73) Assignee: THE COCA-COLA COMPANY, Atlanta, GA (US)

(21) Appl. No.: 10/709,490

(22) Filed: May 10, 2004

Related U.S. Application Data
(60) Provisional application No. 60/482,174, filed on Jun. 24, 2003.

(51) Int. Cl. B62K 21/00

(52) U.S. Cl. 280/87.1

(57) ABSTRACT

A mobile device for promoting the sale of a number of products by a driver. The device may include a steering mechanism with a pair of foot sleds for the driver to stand thereon and a product compartment positioned about the steering mechanism. The products positioned within the product compartment may be within reach of the driver.

### CROSS REFERENCE TO RELATED APPLICATIONS

The present application claims the benefit of U.S. Provisional Application No. 60/482,174, filed on Jun. 24, 2003, incorporated herein by reference.

### BACKGROUND OF INVENTION

The present application relates generally to motorized vehicles and more particularly relates to a single person vehicle with a cooler or other type of cargo space thereon.

The use of vending machines, refrigerators, and other types of product dispensers is well known in the art. Product sales volume from such a device often depends in part on placing the device in a location with sufficient consumer traffic. Because the use of such a device often may be an impulse purchase, the device preferably should be located wherever a sufficient number of consumers may gather or simply pass by.

One drawback with the use of many current devices is that the device may not always be placed where the consumers may be gathered. This lack of availability may be due to the size of the device, the expense of the device, the availability of electrical power, the nature of the terrain, or even aesthetic reasons.

For example, it may not be practical to place a vending machine at a sporting venue when that venue only may be used on a sporadic basis. Rather, human vendors often may be used to distribute products to consumers in the crowd. These vendors, however, can only carry a certain number of products at any given time. There also are certain terrains, such as a beach, where humanly carrying the products may not be practical or efficient.

What is desired, therefore, is a means of transporting products over different distances or terrains so as to reach the consumer. Preferably, the transportation means should be easy to use, efficient, and serve to catch the eye and the interest of the consumer.

### SUMMARY OF INVENTION

The present invention thus provides a mobile device for promoting the sale of a number of products by a driver. The device may include a steering mechanism with a pair of foot sleds for the driver to stand thereon and a product compartment positioned about the steering mechanism. The products positioned within the product compartment may be within reach of the driver.

Specific embodiments may include the steering mechanism having a base pivotably attached to the pair of foot sleds. The steering mechanism may include a pivot pin for the base to pivot thereabout. The steering mechanism may include a pair of poles attached to the base so as to urge the base to pivot about the pivot pin when the driver moves the pair of poles in a clockwise or counterclockwise manner. The steering mechanism may include a pair of front wheels attached to the base and a pair of rear wheels attached to the foot sleds.

A drive mechanism may be associated with the steering mechanism. The drive mechanism may include one or more motors associated with the rear wheels. The drive mechanism may include one or more brakes associated with the rear wheels. The drive mechanism may include a rechargeable battery.

The product compartment may include a lid and a lock out device such that the lock out device renders the drive mechanism inoperative if the lid is open. The lid may be doublely hinged. The product compartment may be removable and may include an insulated shell. The product compartment may include a product lift mechanism. The product lift mechanism may include a base biased towards a first end of the product compartment.

A method herein may provide products to consumers via a scooter with a product compartment. The method may include loading a number of the products within the product compartment, positioning the driver on the scooter in a standing position, driving the scooter, attracting the attention of a consumer, stopping the scooter, and providing the consumer with one of the products.

The step of loading the product compartment may include about 120 twelve (12) ounce bottles or about seventy-two (72) twenty (20) ounce bottles. Driving the scooter may include driving the scooter over pavement, gravel, grass, dirt, or sand. Attracting the attention of the consumer may include the driver standing on the scooter. Attracting the attention of the consumer also may include playing music, hands free steering, banked turns, displaying advertising indicia, or displaying flags or banners. Providing the consumer with one of the products may include the driver standing on the scooter.

A further embodiment may provide for a personal transportation device for promoting the sale of a number of products by a driver. The personal transportation device may include means for the driver to steer the personal transportation device while standing and a product compartment positioned about the steering means. The products may be positioned therein such that the driver has access to the products without dismounting from the personal transportation device.

The product compartment may include an insulated shell and may be removable. The product compartment may include a product lift mechanism. The product lift mechanism may include a base biased towards a first end of the product compartment. The personal transportation device further may include means to drive the personal transportation device associated with the steering means. The product compartment may include a lid and a lock out device such that the lock out device renders the drive means inoperative if the lid is open.

A method herein may provide products to consumers via a single occupant vehicle. The method may include positioning the driver on the single occupant vehicle in a standing position, driving the single occupant vehicle, stopping the single occupant vehicle, and providing the consumer with one of the products while the driver remains standing on the single occupant vehicle.

These and other features of the present invention will become apparent upon review of the following detailed description of the preferred embodiments when taken in conjunction with the drawings and the appended claims.

### BRIEF DESCRIPTION OF DRAWINGS

FIG. 1 is a front perspective view of an embodiment of a vehicle as described herein.

FIG. 2 is a rear perspective view showing use of the vehicle of FIG. 1.

FIG. 3 is a front perspective view of the vehicle of FIG. 1

FIG. 4 is a rear perspective view of the vehicle of FIG. 1

FIG. 5 is bottom plan view of the vehicle of FIG. 1.

FIG. 6 is a front perspective view of the vehicle of FIG. 1 with the outer shell of the product compartment shown as transparent.

FIG. 7 is a perspective view of the product compartment with products positioned therein.

FIG. 8 is a plan view of the front crossbar.

FIG. 9 is a plan view of the connection of the base and foot sleds.

### DETAILED DESCRIPTION

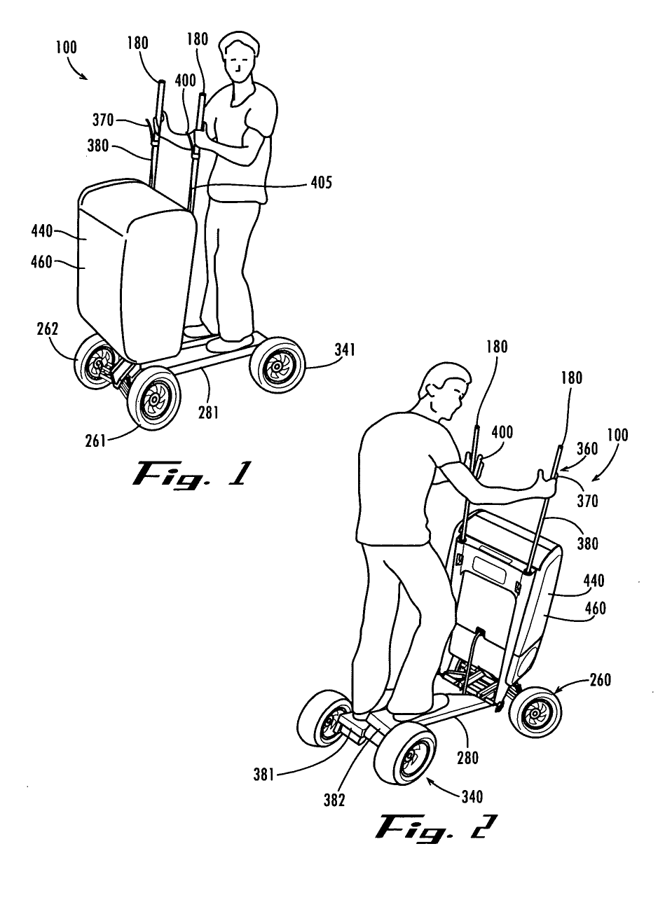

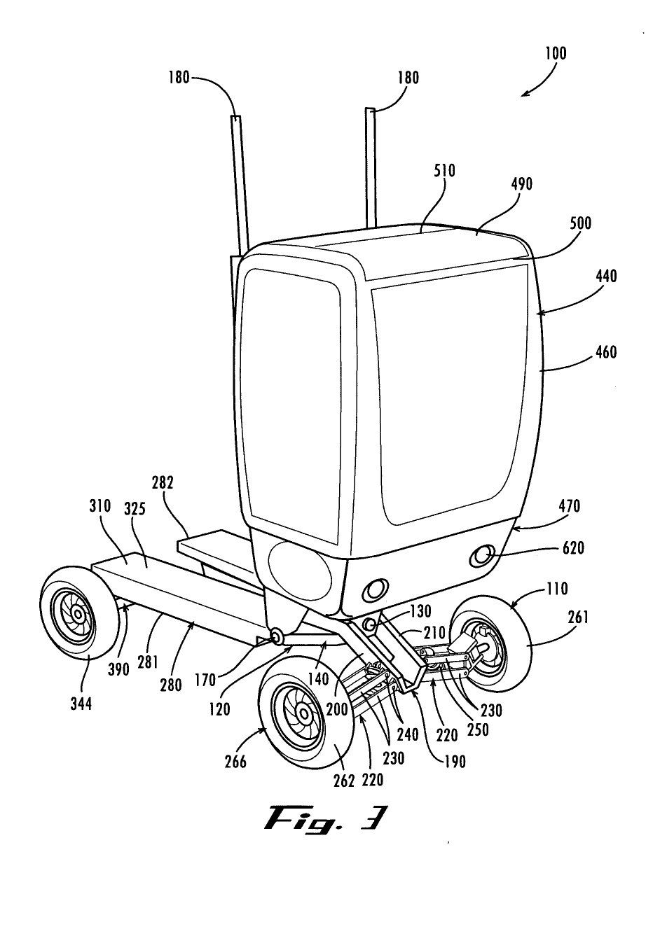

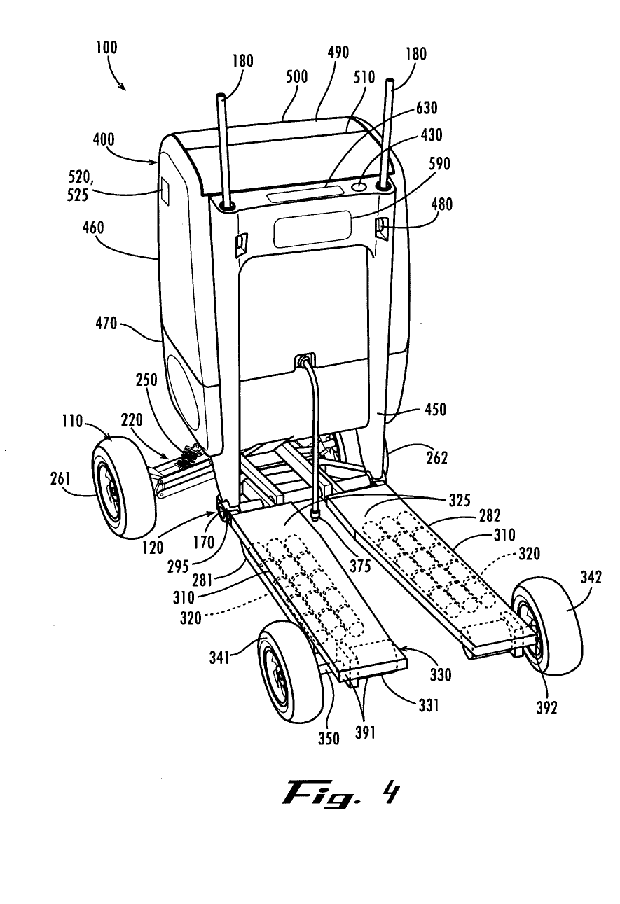

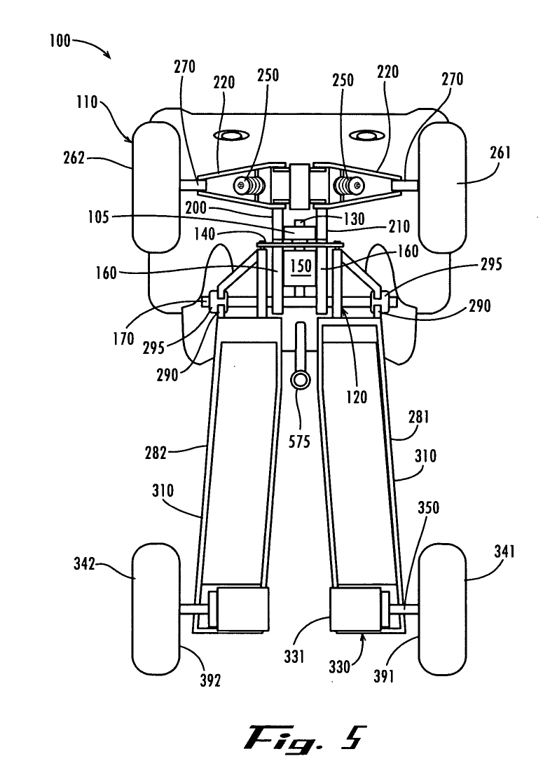

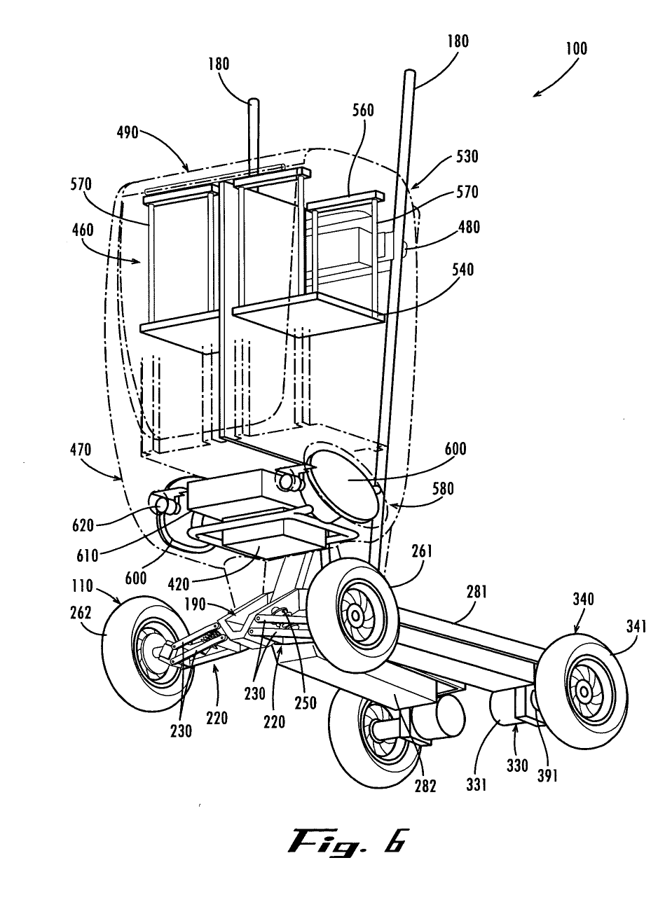

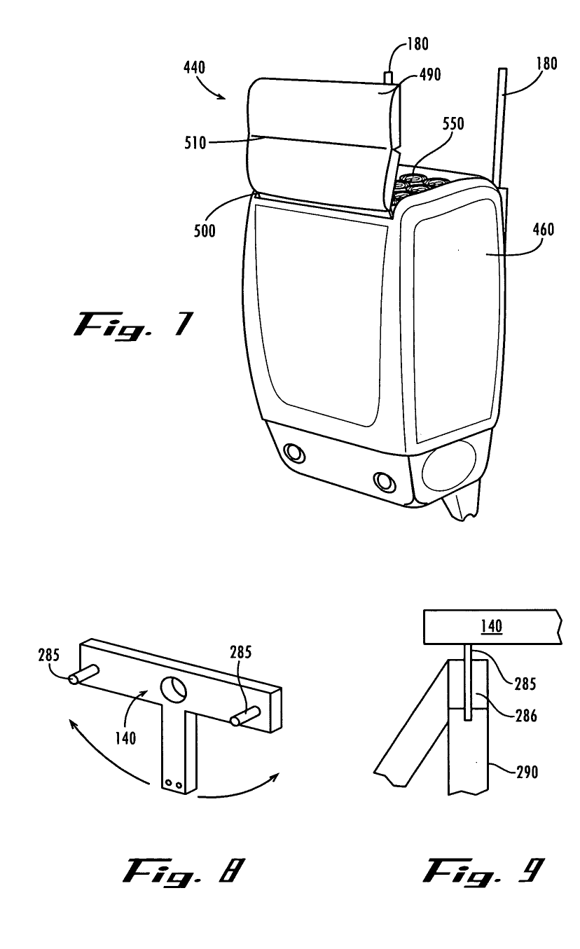

Referring now to the drawings, in which like numerals refer to like parts throughout the several views, FIGS. 1 through 6 show an embodiment of a vehicle 100. The vehicle 100 may carry products and other items as will be described in detail below.

The vehicle 100 may include a steering and drive system 110. The steering and drive system 110 may include a base 120. The steering and drive system 110 also may include a pivot pin 130 for the base 120 to rotate thereabout. The base 120 may include a front crossbar 140 such that the pivot pin 130 may be mounted therethrough. The front crossbar 140 may be largely “T” shaped for connection with a steering linkage as shown in FIG. 8. The base 120 may include a support plate 150 such that the pivot pin 130 also may extend therethrough. The support plate 150 may have a number of lateral supports 160 fixably attached thereto. The base 120 further may include a rear crossbar 170. The rear crossbar 170 may extend through the lateral supports 160 of the support plate 150. The base 120, and the individual components thereof, may be made out of aluminum, steel, or any type of substantially rigid metal, plastic, or composite.

Two (2) upwardly extending poles 180 may be attached to the rear crossbar 170. The poles 180 are fixed with respect to the rear crossbar 170 when attached, but the poles 180 can detach from the rear crossbar 170 for storage. The poles 180 may extend to any convenient length. The poles 180 may be made out of aluminum, steel, or any type of substantially rigid metal, plastic, or composite.

The base 120 may include a wheel frame 190 such that the pivot pin 130 may pivot thereabout. The wheel frame 190 may include two (2) frame members, a first frame member 200 and second frame member 210. The wheel frame 190 may have a crossbar 195 connecting the frame members 200, 210. The frame members 200, 210 may extend downwardly from the base 120 at an angle. The angle may be about fifteen (15) degrees to about forty-five (45) degrees from the horizontal. The wheel frame 190 may be made out of aluminum, steel, or any type of substantially rigid metal, plastic, or composite.

Pivotably attached to the wheel frame 190 may be a pair of wheel struts 220. Each of the wheel struts 220 may include a number of strut members 230 positioned on either side of the wheel frame 190 via one or more pivot points 240. The wheel struts 220 may be made out of aluminum, steel, or any type of substantially rigid metal, plastic, or composite. Each wheel strut 220 also may be attached to the wheel fame 190 by one or more shock absorbers 250. The shock absorbers 250 may be of conventional design.

A pair of front wheels 260, a left front wheel 261 and a right front wheel 262, may be attached to the wheel struts 220 via a gimbal 270 or a similar structure so as to permit free rotation of each front wheel 260 about a vertical axis for steering and about a horizontal axis for forward and reverse motion of the vehicle. The wheels 260 may be of conventional design and may be pneumatic, solid, or any other type. The wheels 260 may have an outer diameter of about six (6) to about twelve (12) inches (about fifteen (15) to about 30.5 centimeters).

The wheel frame 190, the strut members 230, and the gimbals 270 are arranged in a parallelogram shaped linkage mechanism so that the wheels 260 are free to move up and down with respect to the wheel frame 190 in response respectively to increased or decreased load on the vehicle 100 by respectively compressing or decompressing the shock absorbers 250. Going over a bump in the road has the same effect as momentarily increasing the weight of the vehicle 100. The wheels 260 will remain substantially perpendicular to the ground as they move up and down with respect to the wheel frame 190 due to the parallelogram linkage mechanisms described above.

Also pivotably attached to the front crossbar 140 and the rear crossbar 170 of the base 120 are a pair of foot sleds 280, a left foot sled 281 and a right foot sled 282. The foot sleds 280 may be pivotably attached to the rear crossbar 170 via a number of sled flanges 290 with apertures 300 therein. Likewise, the flanges 290 may be connected to a ring 295 that surrounds the rear crossbar 170 for pivotable movement therewith. The flanges 290 may be made out of nylon, acetyl, or any type of substantially rigid metal, plastic, or composite providing reasonably low friction. As is shown in FIG. 9, the foot sleds 280 also may be pivotably attached to the front crossbar 140 via a number of pins 285 attached to the front crossbar 140. The pins 285 may extend into blocks of elastomeric material 286 fastened to the front edge of each foot sled 280. The pins 285 in the elastomeric material 286 accomplish the function of a ball and socket joint. The elastomeric material 286 may be polyurethane, neoprene, or other such material.

The foot sleds 280 themselves may include a pair of foot rests 310 that extend in the direction of travel away from the front wheels 260. Each foot rest 310 may contain a number of batteries 320 formed into a battery pack. These batteries 320 are used to power the motors as is described in more detail below. There is a cover plate 325 on top of each foot rest 310 that protects the batteries 320. The driver may stand on the cover plates 325. The foot sleds 280 may be made out of aluminum, steel or any type of substantially rigid metal, plastic, or composite.

The batteries 320 may be twenty-four (24) to about forty-eight (48) volt batteries. The batteries 320 may be conventional lead-acid, nickel cadmium, metal-air, NiMH, or similar types of low weight, long run time energy sources. The batteries 320 may be replaceable. The batteries 320 also may be rechargeable from a standard outlet by using standard battery chargers. The outlet may be about 120 volts or 240 volts and about 40 to 60 hertz. Preferably, the batteries 320 may be recharged in about four (4) hours or less. The batteries 320 may be rechargeable for more than about 1000 times.

The batteries 320 preferably can power the vehicle 100 for about two (2) to about 2.5 hours or more without a recharge. Alternatively, the batteries 320 may power the vehicle 100 for about twenty (20) to about twenty-five (25) miles (about thirty-two (32) to about forty (40) kilometers) or more without a recharge. Similarly, the vehicle 100 preferably can run for about two (2) to 2½ hours at full power over relatively flat terrain with a full load of the products 550 and an average size driver (about 150 pounds (about 68 kilograms)) without a recharge.

Connected to each foot sled 280 may be a motor 330, a left motor 331 and a right motor 332. The motors 330 may be electrical motor such as about twenty-four (24) to about forty-eight (48) volt DC motors. The motors 330 may have a power output of about 250 to about 500 watts each. Although two motors 330 are shown, one motor 330 may be used.

A set of rear wheels 340, a left rear wheel 341 and a right rear wheel 342, may be connected to each motor 330 for rotation therewith via a drive shaft 350. The rear wheels 340 may be largely identical to the front wheels 260 described above.

An accelerator 360 may govern control of the motors 330. The accelerator 360 may include a conventional hand lever 370 positioned on one of the poles 180. The hand lever 370 may be connected to the motors 330 by a conventional cable 380. The position of the hand lever 370 may be adjustable. The motors 330 and the vehicle 100 as a whole may accelerate up to about fifteen (15) miles per hour (about twenty-four (24) kilometers per hour). Other speeds also may be used depending upon the use of the vehicle 100 as a whole. Any other type of control device may be used with the motors 330.

Also attached to each of the rear wheels 340 may be a brake 390, a left brake 391 and a right brake 392. The brakes 390 may be of conventional design and may be disc brakes, drum brakes, or similar devices. The brakes 390 may be controlled by a brake hand lever(s) 400 that also may be positioned on one or both of the poles 180. The position of the hand lever(s) 400 may be adjustable. The brakes 390 may be connected to the brake hand lever(s) 400 via a conventional cable. Other types of control devices also may be used in addition or instead of the hand lever(s) 400. A parking brake also may be used.

Control of the motors 330 and the vehicle 100 as a whole may be controlled by a standard on/off switch 430. Alternatively, a conventional key or combination may be used to control the motors 330 and the vehicle 100. A conventional dead man switch also may be used to ensure that the vehicle 100 does not move when a driver is not positioned on the foot sleds 280. Conventional turn signals, brake lights, and a horn or other sound device also may be used.

Although the steering and drive system 110 has been described in terms of the base 120, the poles 180, the front wheels 260, the foot sleds 280, the motors 330, the rear wheels 340, and the accelerator 360, any type of steering and drive means may be used. For example, the front wheels 260 may be maneuvered via a conventional linkage, a rack and pinion system, a recirculating ball system, a steering wheel, or similar types of devices. Likewise, the vehicle 100 may a modified Segway® type device (sold by Segway LLC of Manchester, N.H.) or similar types of personal vehicles.

The vehicle 100 also may have a cargo container 440 positioned thereon. The cargo container 440 may be of any convenient size, shape, or dimension. In this embodiment, the cargo container 440 preferably may be insulated and made out of materials with good insulating characteristics such as fiberglass or a molded plastic filled with polyurethane foam, a fiberglass mat, or similar materials.

The cargo container 440 may be mounted onto or adjacent to the steering and drive system 110. Specifically, the cargo container 440 may be attached to the support plate 150 of the base 120 via a support column 450. The cargo container 440 also may be releaseably attached to each of the poles 180.

In this embodiment, the cargo container 440 may be divided into a product compartment 460 and an accessory compartment 470. The cargo container 440 as a whole or simply the product compartment 460 may be removable from the vehicle 100. As described above, the product compartment 460 may be releaseably attached to the poles 180 via a number of locks 480. The locks 480 may be quick release type connectors. Alternatively, a mounting stud sliding into a retention slot or similar types of connectors may be used. If the accessory compartment 470 and the product compartment 460 are separate components, the accessory compartment 470 also may be made out of non-insulated materials such as fiberglass, molded plastic, or similar materials.

The product compartment 460 may have an upper lid 490. The lid 490 may rotate upwards via a product compartment hinge 500. The lid 490 also may be doublely hinged via a lid hinge 510. With the double hinge, the lid 490 need not be opened entirely. The lid 490 may be locked via a lock 520 positioned on the front of the compartment 460. The lid 490 also may have a lockout switch 525 associated with the lock 520. The lockout switch 525 may prevent the motors 330 from operating when the lid 490 is open. The lockout switch 525 may be a magnet/reed switch or similar types of devices. The lid 490 may be mechanized to open and close automatically.

Positioned within the product compartment 460 may be a product lift mechanism 530. The product lift mechanism 530 may include a base 540. The base 540 may accommodate a number of products 550. In this embodiment, the products 550 may be cans or bottles of soft drinks or other types of beverages. Any type of product 550, however, that can be kept heated, chilled, or at room temperature may be used herein. The base 540 may be supported at the top of the product compartment 460 via a frame 560. The base 540 and the frame 560 may be connected via a number of extension springs 570. The springs 570 may be biased to keep an upward pressure on the base 540. As the products 550 are removed from the product compartment 460, the springs 570 force the base 540 towards the lid 490. In addition to the extension springs 570, compression springs, gas springs or similar devices may be used so to urge the products 550 towards the lid 490. The product compartment 460 also may have a drain and/or a drain hose 575 to drain water from therein. The product lift mechanisms 530 can be removed from the product compartment 460 for facilitating cleaning of either the lift mechanism 530 or the interior of the storage compartment 460.

The vehicle 100 also may have an entertainment system 580 positioned thereon. The entertainment system 580 may have an MP3 player 590, a DVD player, a radio, or a similar type of device. The entertainment system 580 may include a number of speakers 600. The speakers 600 may be positioned within the accessory compartment 470. The speakers 600 may be connected to the MP3 player 590 via an amplifier 610. The entertainment system 580 may have its own battery 420 or the entertainment system 580 may use the same batteries 320 that drive the motors 330. The battery 420 may be a twelve (12) volt battery.

The vehicle 100 also may have a pair of headlights 620. The headlights 620 may have about six (6) to about fifteen (15) watts each. The headlights 620 may be positioned within the accessory compartment 470 or elsewhere. Rear or taillights also may be used.

The vehicle 100 also may have a display 630. The display 630 may show information such as battery level, speed, volume, mileage, etc. The display 630 may be a standard liquid crystal display, an LED screen, a touch screen, or a similar type of device. Operation of the vehicle 100 as a whole and the individual components thereof also may be controlled via the display 630.

The vehicle 100 also may any type of graphics positioned thereon. The graphics may be replaceable. The graphics may promote the products 550 positioned within the vehicle 100 or otherwise.

In use, the products 550 may be loaded within the product compartment 460. If the product lift mechanism 530 is used, the products 550 may be loaded on the base 540 thereof. The weight of the products 550 on the base 540 causes the base 540 to descend within the product compartment 460. The springs 570 thus are extended. As the products 550 are removed, the springs 570 urge the base 540 towards the lid 490. The driver may load the product compartment 460 in about five (5) minutes or less.

The driver then may close the lid 490 once the products 550 are loaded. The driver then may mount the vehicle 100 by placing his feet on the foot sleds 280. The driver may turn the on/off switch 430 to the “on” position, thus starting the motors 330. The driver may then depress the accelerator 360, thus moving the vehicle 100 forward. The driver may stop the vehicle 100 by releasing the accelerator 360 and/or depressing the brake lever(s) 400.

When the driver tilts the handlebars 180 clockwise or to the right (from the driver”s perspective), the rear crossbar 170 tilts clockwise as it rotates around the pivot pin 130 because the handlebars 180 are attached directly to the rear crossbar 170. Because the rear crossbar 170 goes pivotally through both foot sleds 280, the clockwise rotation of the rear crossbar 170 causes the front end of the left foot sled 281 to tilt up. The entire left foot sled 281 also tilts to the right. Simultaneously, the front end of the right foot sled 282 tilts down and the entire right foot sled 282 tilts to the right. This unique tilting of the handlebars 180 and foot sleds 280 creates the visual appearance of a “banked” turn. As the front end of the left foot sled 281 moves up and the front end of the right foot sled 282 moves down, the elastomeric blocks 286 in the front ends of the foot sleds 280 engage the pins 285 extending from the ends of the front crossbar 140. This motion causes the front crossbar 140 to rotate clockwise about pivot pin 130. As the front crossbar 140 rotates clockwise, the front crossbar 140 also rotates clockwise the wheel frame 190 and turns the front wheels 260. The driver may facilitate the turn by leaning into the turn. A left hand turn is performed in the opposite manner.

Steering also can be accomplished by the driver shifting his/her weight on the foot sleds 280. If the driver distributes his/her weight evenly on both foot sleds, the rear crossbar 170 will remain horizontal. If the driver leans heavily on the right foot sled 282, the front end of the right foot sled 282 will tilt down rotating the rear crossbar 170 in the clockwise direction. Simultaneously, the front end of the left foot sled 281 will tilt up and the handle bars 180 will tilt to the right. This allows the driver to engage in “eye catching” hands free steering.

The vehicle 100 preferably has the ability to drive on pavement, gravel, grass, dirt, packed sand, and other types of terrains. The vehicle 100 may be able to drive over uneven pavement and climb over a curb or other obstacles of about two (2) to three (3) inches (about five (5) to about 7.6 centimeters). The vehicle 100 may be able to climb about a fifteen percent (15%) grade for about 164 feet (about 50 meters). The vehicle 100 preferably has about a six (6) foot (about 1.8 meters) or less turning radius. The vehicle 100 may have a width such that it can fit through a standard door frame of about thirty-six (36) inches (about 91.4 centimeters). The vehicle 100 also may travel in reverse. A forward/reverse switch may be used or a switch may be found on the display 630.

The charge of the batteries 320 and 420 may be shown on the display 630 or elsewhere. The batteries 320 and 420 may charge at any standard outlet by the use of standard battery chargers. Alternatively, the batteries 320 and 420 may be easily replaced.

The driver may stop the vehicle 100 at any time and provide the products 550 to consumers. The driver may open the lid 490 half-way via the lid hinge 510 so as to remove a product 550. The driver may open the lid 490 completely via the product compartment hinge 500 so as to reload the product compartment 460. The product compartment 460 may hold about 120 twelve (12) ounce products or about seventy-two (72) twenty (20) ounce bottles. The motors 330 may remain inoperative when the lid 490 is open due to the lockout switch 525.

Advantageously, the driver need not dismount from the vehicle 100 while providing the products 550 to the consumer. Rather, the vehicle 100 is steady and balanced while stopped such that driver may reach into the product compartment 460 and provide the product 550 to the consumer. This may serve to speed the sales process and allows the vehicle 100 and the driver to continue to attract attention.

Attention may be brought to the vehicle 100 via the entertainment system 580. Music and/or advertisements may be played via the entertainment system 580. Flags or other items may be attached to the poles 180. The mere fact that the driver is standing in the vehicle 100, however, may be sufficient to attract the attention of the consumer. Attention may also be brought to the vehicle through the appearance of “banked” turns and by “hands free” steering.

The vehicle 100 thus may be ideal for use in sporting events, fairs, parks, beaches, recreational areas, and other types of events and/or locations where conventional vending machines, other types of product dispensers, or even human vendors, may not be appropriate. The vehicle 100 may follow the consumer and generate impulse purchases. The vehicle 100 thus can provide products 550 to consumers over relatively long distances in a quick and efficient manner. Further, the vehicle 100 is unique and serves to catch the eye and attention of the consumer.

When not in use, the vehicle 100 also may fold upon itself. Specifically, the vehicle 100 may collapse about the rear crossbar 170.

It should be understood that the foregoing relates only to the preferred embodiments of the present invention and that numerous changes and modifications may be made herein without departing from the general spirit and scope of the invention as defined by the following claims and the equivalents thereof.

1. A mobile device for promoting the sale of a plurality of products by a driver, comprising:
a steering mechanism;
said steering mechanism comprising a pair of foot sleds for the driver to stand thereon; and
a product compartment positioned about said steering mechanism, with said plurality of products positioned therein within reach of the driver.

2. The mobile device of claim 1, wherein said steering mechanism comprises a base, said base pivotably attached to said pair of foot sleds.

3. The mobile device of claim 2, wherein said steering mechanism comprises a pivot pin, such that said base pivots about said pivot pin.

4. The mobile device of claim 3, wherein said steering mechanism comprises a pair of poles, said pair of poles attached to said base so as to urge said base to pivot about the pivot pin when the driver moves said pair of poles clockwise or counterclockwise.

5. The mobile device of claim 4, wherein said steering mechanism comprises a pair of front wheels, said front wheels attached to said base.

6. The mobile device of claim 5, wherein said steering mechanism comprises a pair of rear wheels, said rear wheels attached to said pair of foot sleds.

7. The mobile device of claim 6, further comprising a drive mechanism associated with said steering mechanism.

8. The mobile device of claim 7, wherein said drive mechanism comprises one or more motors associated with said pair of rear wheels.

9. The mobile device of claim 7, wherein said drive mechanism comprises one or more brakes associated with one of said pair of rear wheels.

10. The mobile device of claim 7, wherein the drive mechanism comprises a rechargeable battery.

11. The mobile device of claim 7, wherein said product compartment comprises a lid and a lock out device such that said lock out device renders said drive mechanism inoperative if said lid is open.

12. The mobile device of claim 1, wherein said product compartment is removable.

13. The mobile device of claim 1, wherein said product compartment comprises a doublely hinged lid.

14. The mobile device of claim 1, wherein said product compartment comprises an insulated shell.

15. The mobile device of claim 1, wherein said product compartment comprises a product lift mechanism.

16. The mobile device of claim 15, wherein said product lift mechanism comprises a base biased towards a first end of said product compartment.

17. A method of providing products to consumers via a scooter with a product compartment, comprising:
loading a plurality of the products within the product compartment;
positioning the driver on the scooter in a standing position;
driving the scooter;
attracting the attention of a consumer;
stopping the scooter; and
providing the consumer with one of the products.

18. The method of claim 17, wherein loading the product compartment comprises about 120 twelve (12) ounce bottles or about seventy-two (72) twenty (20) ounce bottles.

19. The method of claim 17, wherein driving the scooter comprises driving the scooter over pavement, gravel, grass, dirt, or sand.

20. The method of claim 17, wherein attracting the attention of the consumer comprises the driver standing on the scooter.

21. The method of claim 17, wherein attracting the attention of the consumer comprises playing music, displaying advertising indicia, or displaying flags or banners.

22. The method of claim 17, wherein attracting the attention of the consumer comprises hands free steering.

23. The method of claim 17, wherein attracting the attention of the consumer comprises banked turns.

24. The method of claim 17, wherein providing the consumer with one of the products comprises the driver standing on the scooter.

25. A personal transportation device for promoting the sale of a plurality of products by a driver, comprising:
means for the driver to steer the personal transportation device while standing; and
a product compartment positioned about said steering means, with said plurality of products positioned therein such that the driver has access to said plurality of products without dismounting the personal transportation device.

26. The personal transportation device of claim 25, wherein said product compartment comprises an insulated shell.

27. The personal transportation device of claim 25, wherein said product compartment comprises a product lift mechanism.

28. The personal transportation device of claim 27, wherein said product lift mechanism comprises a base biased towards a first end of said product compartment.

29. The personal transportation device of claim 25, further comprising means to drive the personal transportation device associated with said steering means.

30. The personal transportation device of claim 29, wherein said product compartment comprises a lid and a lock out device such that said lock out device renders said drive means inoperative if said lid is open.

31. The personal transportation device of claim 25, wherein said product compartment is removable.

32. A method of providing products to consumers via a single occupant vehicle, comprising:
positioning the driver on the single occupant vehicle in a standing position;
driving the single occupant vehicle;
stopping the single occupant vehicle; and
providing the consumer with one of the products while the driver remains standing on the single occupant vehicle.
